(19) United States
(12) Patent Application Publication
(10) Pub. No.: US 2010/0191703 A1
(43) Pub. Date: Jul. 29, 2010

(54) METHOD FOR TRANSMITTING INFORMATION BETWEEN VEHICLE IDENTIFIERS

(75) Inventors: Fabienne Masson, Creteil Cedex (FR); Jean-Claude Huth, Cretil Cedex (FR)

Correspondence Address: OSHA LIANG L.L.P., TWO HOUSTON CENTER, 909 FANNIN, SUITE 3500, HOUSTON, TX, 77010, US

(73) Assignee: VALEO SECURITE HABITACLE, Creteil Cedex (FR)

(21) Appl. No.: 12/665,956

(22) PCT Filed: Jun. 16, 2008
(86) PCT No.: PCT/EP08/57576

§ 371 Date: Mar. 31, 2010

(30) Foreign Application Priority Data
Jun. 25, 2007 (FR) 07/04548

(51) Int. Cl. G06F 17/30

(52) U.S. Cl. 707/621; 707/E17.005

(57) ABSTRACT

The invention relates to a method for transmitting information from a first identifying object (ID1) for a motor vehicle to a second identifying object (ID2), the said method comprising the steps of: activating a synchronization mode (MOD₁₃ SYNC); opening a two-way communication session; and transmitting information from one identifying object (ID1) to another identifying object (ID2) according to a date associated with the information to be transmitted. Application: motor vehicle.

### FIELD OF THE INVENTION

The present invention relates to a method for transmitting information from a first identifying object for a motor vehicle to a second identifying object, an identifying object allowing access to said vehicle, and a transmission device making it possible to apply said method.

It finds a particular application in the field of motor vehicles.

### DESCRIPTION OF THE PRIOR ART

In the case of a motor vehicle application, according to known prior art, when a user gains access via an identifying object, such as a hands-free portable badge, to a vehicle, information concerning notably the vehicle may be recorded in said identifying object, such as for example the pressure of the wheel tires or else the gasoline level. This information can be updated each time the vehicle is accessed, and therefore represents in this case the information at the time of the last vehicle access by the user. This information is, for conventional badges, available from the manufacturer of the vehicle. A problem with this known prior art is that, if there is a plurality of identifying objects for one and the same vehicle, the information contained in the two identifying objects is not always the same if the user does not access his vehicle with the two identifying objects at the same time. Accordingly, the vehicle information may be obsolete in one of the identifying objects and may generate interpretation errors in the case, for example, of a manufacturer diagnosis etc. Moreover, the manufacturer may no longer know which information was updated at the time of the last vehicle access and in which identifying object it exists.

### OBJECT OF THE INVENTION

The object of the present invention is notably to solve the problem cited above and in particular to have exact information corresponding to the last vehicle access in any identifying object.

According to a first object of the invention, this object is achieved by a method for transmitting information from a first identifying object for a motor vehicle to a second identifying object, an identifying object allowing access to said vehicle, said method comprising the steps of:
activating a synchronization mode;
opening a two-way communication session; and
transmitting information from one identifying object to the other identifying object depending on a date associated with the information to be transmitted.

As will be seen in detail below, such a method has the advantage of obtaining an update of the information in all the identifying objects allowing access to one and the same vehicle, even if an identifying object has itself not allowed the last access to the vehicle, by virtue of a synchronization of the information between identifying objects that communicate with one another.

According to nonlimiting embodiments, the method also has the following features.
The two-way communication is radiofrequency communication. This allows two identifying objects to communicate at a distance without consuming energy.
A transmission of information is based on a comparison of dates associated respectively with information comprised in the first identifying object and with information comprised in the second identifying object. This makes it possible to know which information is the most up-to-date and in which identifying object.
A date corresponds to information updated after an access to the vehicle by an identifying object. This makes it possible to know which identifying object was the last to access the vehicle.
The opening of a communication session occurs after a check of a vehicle number. This allows one identifying object to communicate with the other identifying objects which have authorization to access the same vehicle as it.
The activation of the synchronization mode is carried out manually. It is a simple way of initiating the synchronization of the information in one identifying object with another identifying object.
A transmission of information is carried out in a plurality of packets. This allows a more modular transmission of information. That is to say that information of the same type can be grouped together.
At least one date is transmitted when a two-way communication session is opened. This makes it possible to save execution time relative to transmitting a date after a session is opened.

A second subject of the invention relates to a device for transmitting information from a first identifying object for a motor vehicle to a second identifying object, an identifying object allowing access to said vehicle, said device comprising:
a control unit for:
   activating a synchronization mode;
   opening a two-way communication session; and
   transmitting information from one identifying object to the other identifying object depending on a date associated with the information to be transmitted.

A third subject of the invention is an identifying object for a motor vehicle capable of transmitting information to another identifying object, an identifying object allowing access to said vehicle, and comprising:
a man-machine interface in order to select a synchronization mode;
a transceiver for physically transmitting information to another identifying object; and
a device for transmitting information as claimed in the preceding feature.

A fourth subject of the invention is a computer program product comprising one or more sequences of instructions that can be executed by an information-processing unit, the execution of said sequences of instructions allowing the application of the method as claimed in any one of the preceding features.

### BRIEF DESCRIPTION OF THE FIGURES

Other features and advantages of the present invention will be better understood with the aid of the description and of the nonlimiting drawings amongst which:

FIG. 1 represents a diagram of a transmission of information between a first identifying object and a second identifying object according to a first nonlimiting embodiment of the transmission method according to the invention;

FIG. 2 represents a first continuation of the diagram of FIG. 1;

FIG. 3 represents a second continuation of the diagram of FIG. 1;

FIG. 4 represents a diagram of a transmission of information between a first identifying object and a second identifying object according to a second nonlimiting embodiment of the transmission method according to the invention;

FIG. 5 represents a first continuation of the diagram of FIG. 4;

FIG. 6 represents a second continuation of the diagram of FIG. 4;

FIG. 7 represents a variant embodiment of FIG. 2; and

FIG. 8 is a diagram of the transmission device allowing the application of the method of FIG. 1.

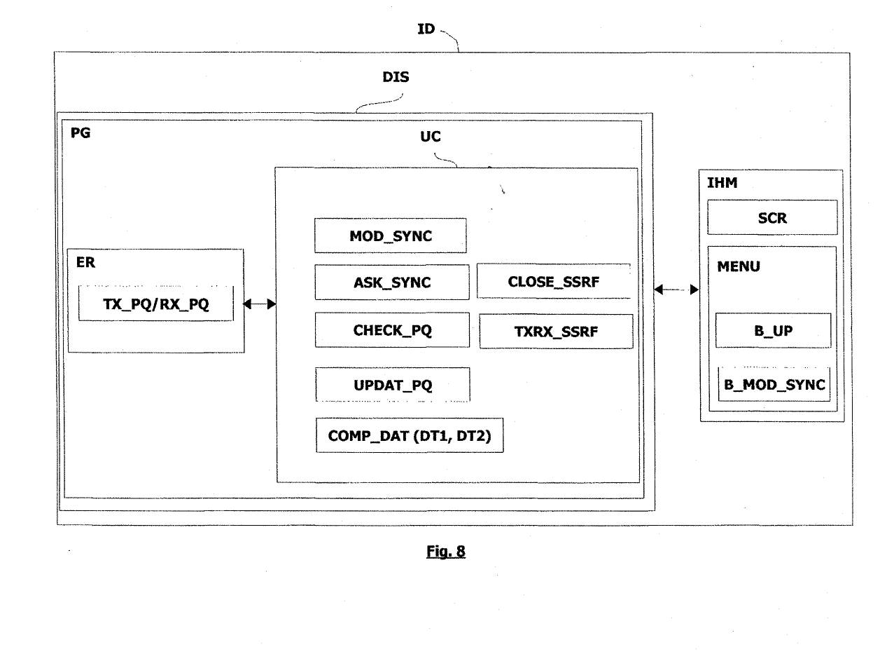

### DETAILED DESCRIPTION OF NONLIMITING EMBODIMENTS OF THE INVENTION

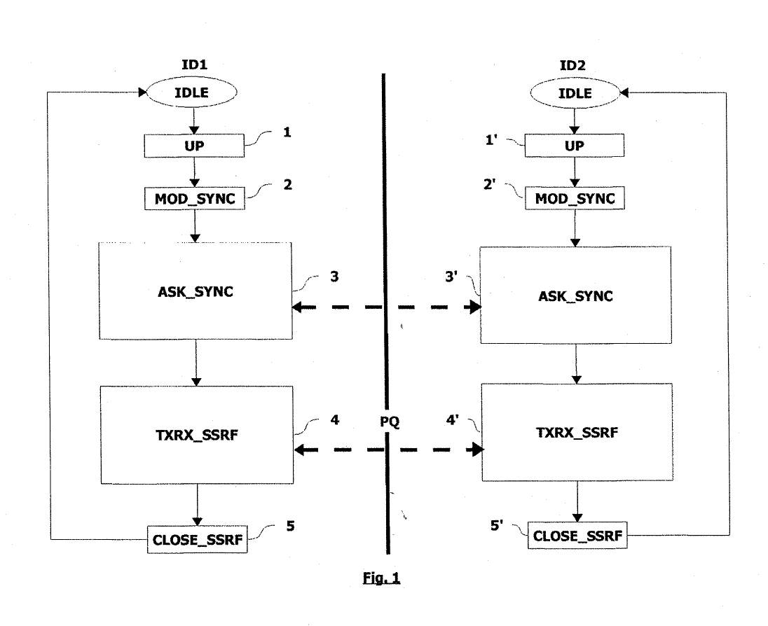

The method for transmitting information according to the invention is described in a nonlimiting embodiment in FIG. 1.

In the example of FIG. 1, the steps of the method for two identifying objects ID1 and ID2 are shown. An identifying object ID allows access to a motor vehicle. In nonlimiting examples, it takes the form of a badge, a key, a key fob, etc. It usually comprises a man-machine interface IHM with a screen and a menu SCR, and an electronic module making it possible to transmit a wireless signal to a receiver coupled to a computer on board the vehicle. Such identifying objects are known to those skilled in the art and are therefore not described here.

The method for transmitting information from one identifying object to another identifying object notably comprises the following steps:
a wakeup step UP;
a step of activating a synchronization mode MOD_SYNC;
a step of requesting synchronization ASK_SYNC in which a two-way communication session is opened OPEN_SSRF;
a step of transmitting information TXRX_SSRF; and
a step of closing a session CLOSE_SSRF.

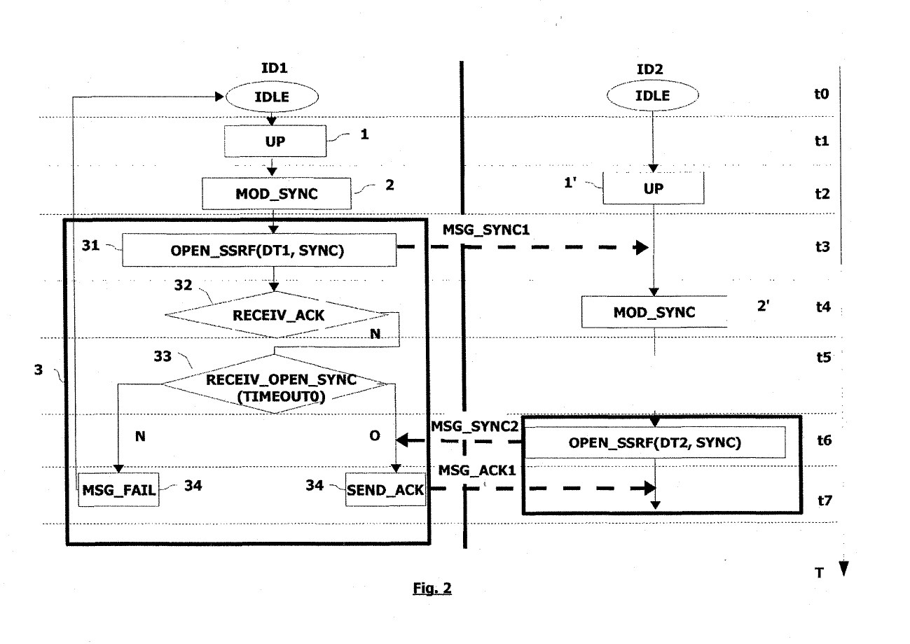

The steps are described in detail below with reference to FIGS. 2 to 7.

In these figs, a time axis T and the various steps along this time axis are shown.

At time t0, the figure begins from an initial state of an identifying object ID which is an idle state IDLE.

In a first step 1), an identifying object ID is woken up.

In the example of FIG. 2, the first identifying object ID1 is woken up first at time t1, while the second identifying object ID2 is woken up afterwards at time t2.

The objects are woken up for example manually by means of a man-machine interface MMI of the identifying object ID described below in the description (for example by pressing a button), or else automatically by means of low-frequency waves either without contact or with contact when the identifying object ID is close to a low-frequency base called BF situated in the vehicle for example. It is also possible to do it automatically with a radiofrequency signal called RF.

In a second step 2), a synchronization mode MOD_SYNC is activated which will make it possible to transmit information between identifying objects ID.

In a nonlimiting example, the activation is carried out manually by means of the man-machine interface MMI of the identifying object ID described below.

In the example of FIG. 2, the synchronization mode MOD_SYNC is activated at time t2 for the first identifying object ID1 and at time t4 for the second identifying object ID2.

This manual activation makes it possible to consume less energy than with an automatic activation.

Naturally, an automatic activation of synchronization can also be envisaged, but it requires more resources because it assumes the detection of an identifier in a zone and the use of an automatic two-way communication.

In a third step 3), a synchronization is requested ASK_SYNC in the following manner.

With respect to the first identifying object ID1, the one that was woken up first, in a first substep 31), the synchronization request ASK_SYNC comprises an opening of a two-way communication session OPEN_SSRF.

In a nonlimiting embodiment, the two-way communication session is radiofrequency communication. This will allow the identifying objects ID to communicate with one another and at a distance if necessary. In the rest of the description, this nonlimiting example of a radiofrequency RF communication session is taken.

This session is opened OPEN_SSRF via a signal, in this instance a radiofrequency (RF) signal MSG_SYNC1 which is therefore sent to the second identifying object ID2, in this instance at time t3.

In order to know to which second identifying object ID2 it is necessary to send the synchronization request, a number NS relating to this second identifying object ID2 is used.

In a first nonlimiting example, this number NS is the number of the vehicle V to which all the identifying objects have access.

Specifically, such a vehicle number is recorded in memory in all the identifying objects that allow access to said vehicle V. Therefore, in the example taken, the first and second identifying objects ID1 and ID2 have this number in memory.

In a second nonlimiting example, this number NS is a number specific to the second identifying object ID2 which will therefore also be recorded in memory in the first identifying object ID1.

Therefore, a synchronization request ASK_SYNC and hence an opening of a communication session OPEN_SSRF takes place after the vehicle number has been checked.

In a second substep 32), the first identifying object ID1 checks that an acknowledgement ACK has been returned by the second identifying object ID2. This makes it possible to check whether the second identifying object ID2 is available (that is to say woken up and in synchronization mode).

As can be seen in the example of FIG. 2, no acknowledgement ACK has been sent by the second identifier ID2. The check that is made in this instance at time t4 is therefore negative.

It will be noted that the case in which an acknowledgement ACK is received by the first identifier ID1 corresponds to the case explained in the context of the second identifier ID2. Reference should therefore be made to the description for the second identifier ID2 below during the fourth step.

In a third substep 33), since it has received no acknowledgement ACK, the first identifier ID1 waits for a radiofrequency communication signal for a determined time TIMEOUT0. In a nonlimiting example, this time is set at 5 seconds.

As can be seen in FIG. 2, it receives a message MSG_ASK2 from the second identifier ID2, at time t6, corresponding to a communication signal RF which asks it for a synchronization.

At this moment, in a fourth substep 34), at time t7, the first identifier ID1 sends an acknowledgement ACK via a message MSG_ACK1 to the second identifier ID2 in order to notify it that it is available for carrying out a synchronization.

Therefore, the receipt of an acknowledgement ACK means that a two-way radiofrequency communication session is initialized for the first identifying object ID1 and the second identifying object ID2.

It will be noted that, if the check made in the third substep 33 is negative, after the determined time TIMEOUT0, a message MSG_FAIL is sent meaning that the synchronization request has failed and there is a return to the idle state IDLE. This message allows a user of the first identifying object ID1 to know that the second identifier ID2 is not available.

The two-way radiofrequency communication session SSRF will subsequently allow an interchange of information between the two identifying objects ID1 and ID2 in the form of radiofrequency signals RF.

Note that a radiofrequency signal RF is situated around 433 MHz. It is possible to go up to GigaHz for the radiofrequency signal RF depending on the frequency bands available for various countries (315 MHz for Asia, 868 MHz for certain countries of Europe or 915 MHz in America etc.).

Naturally it would be possible to use other frequencies for the radiofrequency signals allowing a remote communication. The signals RF are higher than 1 MHz unlike the low-frequency signals BF.

Therefore, the two identifying objects ID1 and ID2 can communicate if they are at a distance of several hundreds of meters, usually between 100 and 600 meters with a typical value of 200 meters for 868 MHz for example.

For example, if the first identifying object ID1 is close to the vehicle V and if the second identifying object ID2 is in the dwelling of the user of the vehicle V, they will be able to communicate.

With respect to the second identifying object ID2, when it receives a synchronization request ASK_SYNC from the first identifying object ID1 at time t3, nothing happens because it is not available. The synchronization mode has not yet been selected in it in the example taken in FIG. 2.

It is only at time t4 that the synchronization mode is selected MOD_SYNC in the second identifier ID2.

At time t6, the second identifier ID2 sends a synchronization request ASK_SYNC via a message MSG_ASK2 to the first identifier ID1, this request ASK_SYNC comprising an opening of a two-way communication session OPEN_SSRF.

At time t7, the second identifier ID2 therefore receives an acknowledgement ACK via a message MSG_ACK1 from the first identifier ID1 indicating to it that the latter is available for a synchronization.

In a nonlimiting embodiment, a data frame (not shown) is therefore used for:
the opening of an RF communication session OPEN_SSRF, and
the transmission of an acknowledgement ACK.

In a nonlimiting embodiment, this frame comprises a synchronization bit SYNC making it possible to know that a synchronization request is made. This bit is therefore enabled for a synchronization request ASK_SYNC when the communication session is opened OPEN_SSRF.

Moreover, in a nonlimiting embodiment, in this frame, a date DT associated with information PQ comprised in the identifying object is sent when the communication session is opened OPEN_SSRF. As will be seen below, this date DT corresponds to information updated after the vehicle V has been accessed by an identifying object ID.

As can be seen in the example illustrated in FIG. 2, a date DT1 associated with information in the first identifying object ID1 is sent to the second identifier ID2 during the synchronization request ASK_SYNC (and therefore the opening of the session OPEN_SSRF) by the first identifying object ID1, while a date DT2 associated with information in the second identifying object ID2 is sent to the first identifying object ID1 during the synchronization request ASK_SYNC (and therefore the opening of the session OPEN_SSRF) by the second identifier ID2.

In a fourth step 4), information is transmitted between the two identifying objects ID1 and ID2.

The transmitted information is in a nonlimiting example of the information relating to the vehicle.

It relates for example to:
the state of the vehicle V,
the position of the vehicle V.

With reference to the state of the vehicle V, it is possible notably to have the following data:
temperature of the engine, and/or of the electronic circuits;
battery level, gasoline level, oil level;
pressure of the tires;
state of the vehicle preventilation or preheating;
rear and front doors closed/open, trunk closed/open;
total mileage and daily mileage;
etc.

With reference to the position of the vehicle V, it is possible to have notably the following data:
the GPS (Global Positioning System) location of the vehicle when the latter is stopped for example; and
one or more destination addresses.

Naturally, other information may be transmitted whether or not associated with the vehicle, such as for example a graphic environment of an identifying object ID.

As will be seen in detail below, the information described above, in the nonlimiting example, is vehicle information that is updated after an access to said vehicle V by an identifying object ID.

The information to be transmitted will therefore be that corresponding to the last vehicle access so that each identifying object understands the same information and the most recent. During the update of the information, an update date is saved in the identifying object. This date associated with the update of the information will make it possible to determine which information therefore corresponds to the last vehicle access. The transmission of information will therefore be based on this date and be determined in particular according to a comparison of dates associated respectively with vehicle information comprised in the first identifying object and with vehicle information comprised in the second identifying object.

In a first nonlimiting embodiment, a comparison of dates is made in a single identifying object, and the information of which the date is the most recent will be transmitted to the identifying object comprising the oldest information so that it can be updated.

In a second nonlimiting embodiment, the information will be transmitted from one to the other, and a comparison of dates will be made in each identifying object which, depending on the result, may or may not update its information with that received from the other identifying object.

In consequence, a good synchronization of the information between identifying objects will be obtained.

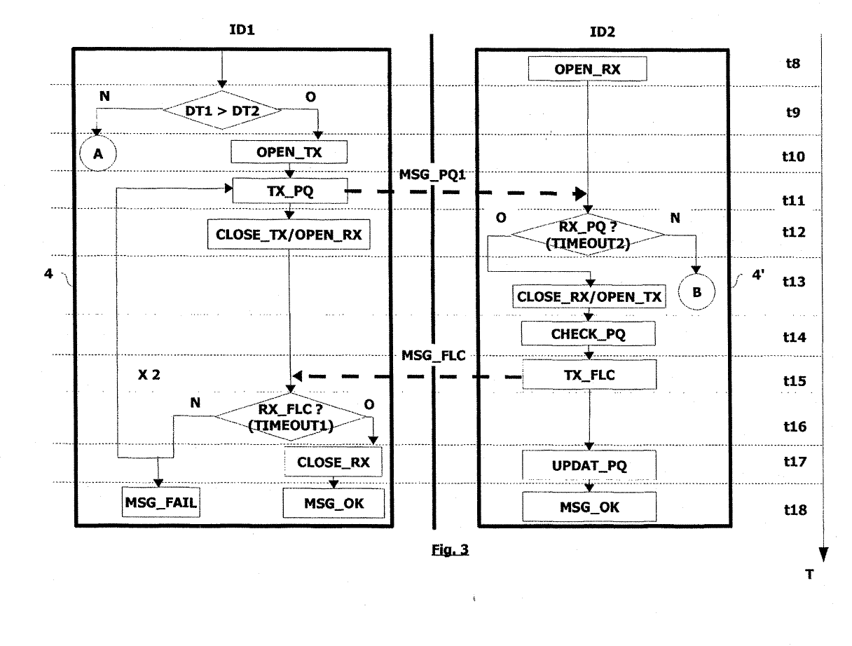

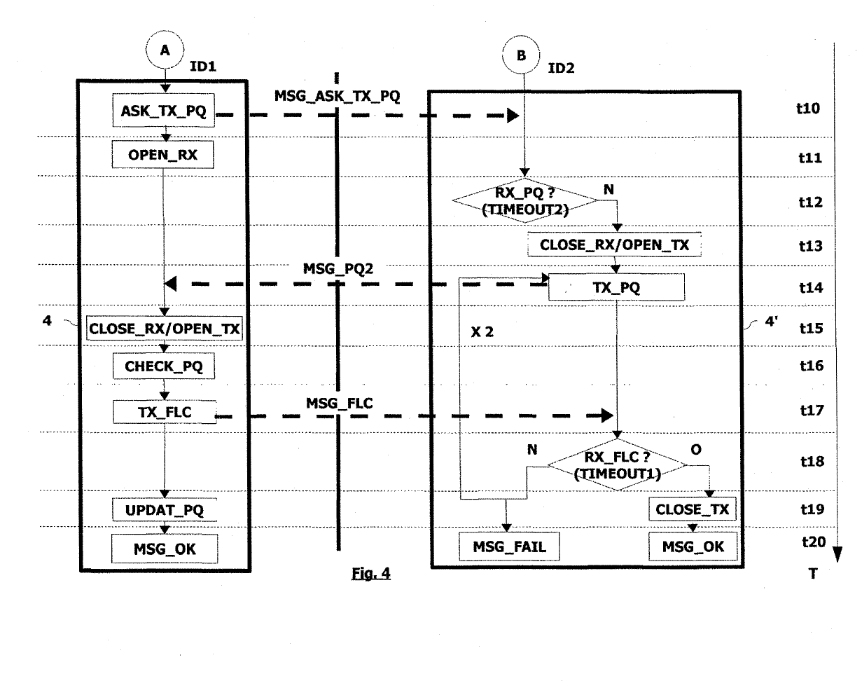

Therefore, in a first nonlimiting embodiment, the transmission is carried out in the following manner and is described in detail in FIGS. 3 and 4.

In this first embodiment, only the information comprised in a single identifying object is transmitted and a single comparison of date is made in a single identifying object.

In this first embodiment, the first identifying object ID1 will behave as the master and the second identifying object ID2 will behave as the slave. That is to say that it is the first identifying object ID1 that will take the initiatives for the actions while the second identifying object ID2 will await instructions originating from the first identifying object ID1.

After a communication session has been opened in an identifying object ID,
At time t8, the second identifying object ID2 sets itself to receive mode OPEN_RX, because it is the slave. It awaits the instructions from the first identifying object ID1.
At time t9, with respect to the first identifying object ID1, after receipt of the date DT2 relating to the vehicle information contained in the second identifying object ID2 (received when the communication session is opened), the first identifying object ID1 makes a comparison of dates.

It checks whether the date DT2 of the information contained in the second identifier ID2 is prior to the date DT1 of its own information. Naturally, the comparison may also begin at time t8.

Initially, take the case in which the first date DT1 is subsequent to the second date DT2.
At time t10, if its date DT1 is subsequent to the date DT2, then the first identifying object ID1 sets itself to transmit mode OPEN_TX, and
At time t11, it transmits the information PQ1 by means of an RF signal MSG_PQ1 to the second identifying object ID2.
Then, at time t12, the first identifying object ID1 closes its position in transmit mode CLOSE_TX and sets itself to receive mode OPEN_RX, while the second identifying object ID2 checks that it has received information PQ1 from the first identifying object ID1 (step RX_PQ illustrated in FIG. 3). The polling for the receipt of information PQ takes place during a third determined period TIMEOUT2. If this time is exceeded, a failure message MSG_FAIL is displayed. This period TIMEOUT2, in a nonlimiting example, is taken to be equal to 1 second.
In the affirmative, if the information PQ1 has been received, at time t13, the second identifying object ID2 closes its receive mode CLOSE_RX and sets itself in transmit mode OPEN_TX.
At time t14, the second identifying object ID2 checks the integrity of the information that it has received (step CHECK_PQ illustrated in FIG. 3). It uses, for example, a known verification algorithm such as a checksum or any other algorithm known to those skilled in the art.
At time t15, the second identifying object ID2 returns a control signal FLC (called “Flow Control”) via an RF signal MSG_FLC (the step TX_FLC illustrated in FIG. 3) if the received information is correct (the check is positive).

In another variant, the control signal FLC is always returned and its value (for example 0 or 1) determines the result of the integrity check.
At time t16, the first identifying object ID1 polls a receipt of a control signal FLC. Naturally, it may begin polling at time t13.

According to the first variant (control signal sent only when the information is correct), this polling takes place during a second determined time period TIMEOUT1. In a nonlimiting embodiment, the second determined period TIMEOUT1 for polling is defined so that it is longer than the time taken by the second identifying object ID2 to:
check the received information CHECK_PQ;
return the control signal FLC; and
update the received information UPDAT_PQ.

This period TIMEOUT1, in a nonlimiting example, is taken to be equal to 1 second.
At time t17, at the end of this period TIMEOUT1, if no control signal FLC has been received or if its value is negative (the information is not correct), a message MSG_FAIL is displayed on the screen of the first identifying object ID1 indicating a failure of the synchronization of information between the two identifying objects.

Conversely, if the first identifying object ID1 receives a control signal FLC during this period TIMEOUT1, it knows that the transmitted information has been correctly transmitted and synchronized according to the first variant or otherwise, according to the second variant, it checks the value of the control signal FLC to see if the information has been correctly transmitted and synchronized.
At time t17, if the information has been correctly transmitted, the first identifying object ID1 closes its transmit mode CLOSE_TX. Otherwise, it tries again to send its information PQ1 a determined number of times. For example, it retries twice to resend the information.
If the return of information fails after two attempts for example, then at time t18, a message MSG_FAIL is displayed on the screen of the first identifying object ID1 indicating a failure of the synchronization of information between the two identifying objects.
On its side, if the information transmitted by the first identifying object ID1 is correct, at time t17, the second identifying object ID2 updates its information by replacing it with that transmitted by the first identifying object ID1 (step UPDAT_PQ illustrated in FIG. 3).
At time t18, the first and the second identifying objects ID1 and ID2 display on their respective screen a success message MSG_OK indicating that the synchronization of information has succeeded.

We have just seen the situation in which the first date DT1 is subsequent to the second date DT2.

We will now see below the situation in which the first date is prior to the second date DT2 (points A and B in FIG. 3). This situation is illustrated in FIG. 4.
At time t10, the first identifying object ID1 asks the second identifying object ID2 for the transmission of information (step ASK_TX_PQ illustrated in FIG. 4) via an RF signal MSG_ASK_TX_PQ.
Then, at time t11, the first identifying object ID1 sets itself to receive mode OPEN_RX.
At time t12, the second identifying object ID2 is already in receive mode OPEN_RX (see time t8 described above in FIG. 3). It checks whether it has received information. It has not received any, but it sees that it receives an information transmission request from the first identifying object ID1.
Following this, at time t13, the second identifying object ID2 closes its receive mode position CLOSE_RX and sets itself to transmit mode OPEN_TX.
Then, at time t14, the second identifying object ID2 sends its vehicle information PQ2 via an RF signal MSG_PQ2 to the first identifying object ID1 (step TX_PQ).
At time t15, after receiving information originating from the second identifying object ID2, the first identifying object ID1 closes its receive mode position CLOSE_RX and sets itself to transmit mode OPEN_TX.
Then, at time t16, it checks the integrity of the information (as described above in FIG. 3 for the second identifying object ID2) (step CHECK_PQ).
At time t17, if the information PQ2 is correct, the first identifying object ID1 returns a control signal FLC to the second identifying object ID2 via an RF signal MSG_FLC (step TX_FLC), otherwise, a message MSG_FAIL is displayed on its screen indicating a failure of the synchronization. The second variant described above may also be used (always send a control signal FLC and a different value depending on whether a transmission is correct or not).
At time t18, the second identifying object ID2 polls and checks whether it has received the control signal FLC. The polling and checking take place according to the first or second variant described above.
In the affirmative (if it has received a control signal or depending on the value of the received signal), at time t19, it closes its transmit mode CLOSE_TX. In the situation of the second variant, note that it checks the value of the control signal FLC first. At time t19, with respect to the first identifying object ID1, it updates its information with that received from the second identifying object ID2 (step UPDAT_PQ).
In the negative, at time t19, the second identifying object ID2 retries to resend the information PQ2, in the example taken, the retransmission attempt is set at two attempts.
If the transmission still fails, at time t20, the second identifying object ID2 displays a message MSG_FAIL on its screen indicating the failure of the synchronization of information between the two identifying objects.
By contrast, if the transmission of the information from the second identifying object ID2 to the first identifying object ID1 has succeeded, at time t20, a success message MSG_OK is displayed on the screen of the first identifying object ID1 and of the second identifier ID2 indicating that the synchronization of the information has succeeded.

Therefore, thanks to this first embodiment, the two identifying objects ID1 and ID2 have up-to-date and synchronized information, that is to say that they have the same information corresponding to the last vehicle access. A single comparison of dates DT1 and DT2 is carried out, and it is made in the first identifying object ID1, the one in which the synchronization mode MOD_SYNC was enabled first.

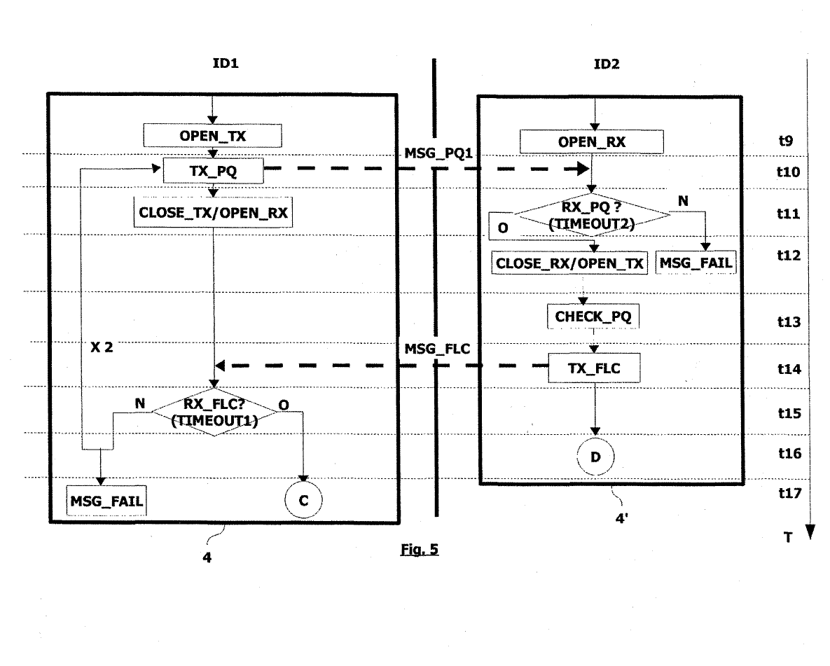

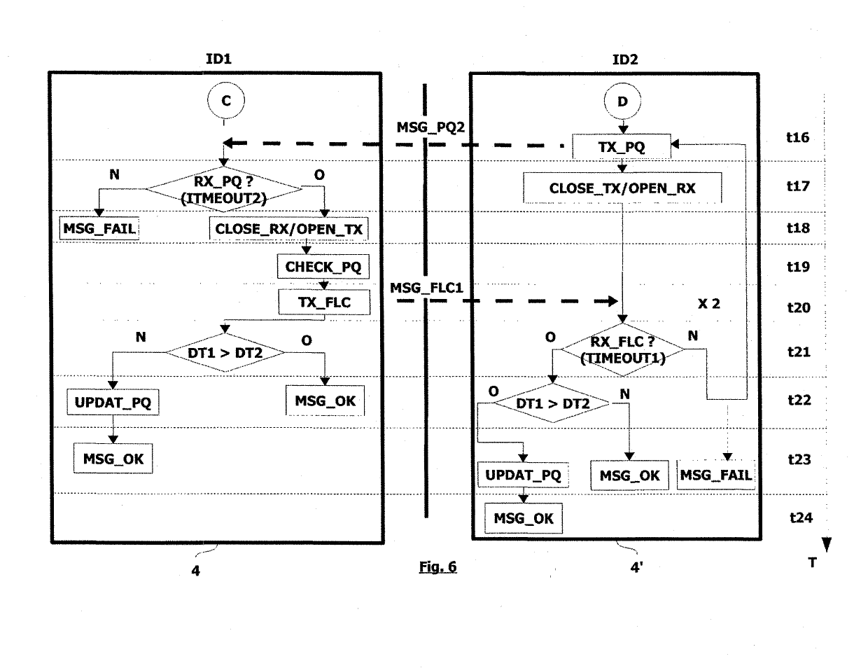

In a second nonlimiting embodiment, the transmission is carried out in the following manner and is described in detail in FIGS. 5 and 6.

In this second embodiment, the information comprised in the two identifying objects is transmitted, and a comparison of dates is carried out in each of the identifying objects.

After a communication session is opened in an identifying object ID,
At time t9, the first identifying object ID1 sets itself to transmit mode OPEN_TX while the second identifying object ID2 is set to receive mode OPEN_RX.
At time t10, the first identifying object ID1 transmits its vehicle information PQ1 via an RF signal MSG_PQ1 to the second identifying object ID2.
At time t11, the first identifying object ID1 closes its position in transmit mode CLOSE_TX and sets itself to receive mode OPEN_RX, while the second identifying object ID2 checks that it has received information PQ1 from the first identifying object ID1 (step RX_PQ illustrated in FIG. 5). The polling for the receipt of information PQ is carried out during a third determined period TIMEOUT2. If this period is exceeded, the failure message MSG_FAIL is displayed on the screen of the second identifying object ID2.
In the affirmative, if the information PQ1 has been received, at time t12, the second identifying object

ID2 closes its receive mode CLOSE_RX and sets itself to transmit mode OPEN_TX. In the negative, a message MSG_FAIL is displayed on its screen indicating a failure of the synchronization of the information. The polling of the receipt of information PQ1 is carried out during a third determined period TIMEOUT2. If this period is exceeded, the failure message MSG_FAIL is displayed.
At time t13, the second identifying object ID2 checks the integrity of the information that it has received (step CHECK_PQ illustrated in FIG. 5).
Then, at time t14, the second identifying object ID2 returns a control signal FLC according to the first variant or second variant described above via an RF signal MSG_FLC (step TX_FLC illustrated in FIG. 5).
At time t15, the first identifying object ID1, for its part, polls a receipt of a control signal FLC. According to the first variant, this polling is carried out during a second determined time period TIMEOUT1. Naturally, this polling may begin at time t12; just after the setting to receive mode OPEN_RX.

At the end of this second period TIMEOUT1, if no control signal has been received, a message MSG_FAIL is displayed on the screen of the first identifying object ID1 indicating a failure of the synchronization of information between the two identifying objects.

If the first identifying object ID1 receives a control signal FLC during this second period TIMEOUT1, it knows that the transmitted information has been correctly transmitted according to the first variant, or otherwise, according to the second variant, it checks the value of the control signal FLC to see if the information has been correctly transmitted.
At time t16, if the information has not been correctly transmitted, the first identifying object ID1 retries to send its information PQ1 a determined number of times. For example, it retries twice to resend the information.
At time t17, if the resending of information fails after two attempts for example, a message MSG_FAIL is displayed on the screen of the first identifying object ID1 indicating a failure of the synchronization of information between the two identifying objects.

The continuation of this second embodiment is illustrated in FIG. 6.
If the information PQ1 transmitted by the first identifying object ID1 is correct (a control signal has been sent at time t14 by the second identifying object ID2), at time t16, the second identifying object ID2 transmits in its turn its vehicle information PQ2 to the first identifying object ID1 via an RF signal MSG_PQ2.
At time t17, the second identifying object ID2 closes its transmit mode CLOSE_TX and sets itself to receive mode OPEN_RX.
At time t17 to t20, the first identifying object ID1 carries out the same steps described for the receipt of information from the second identifying object ID2 above in FIG. 5, namely:
   the polling of the receipt of information (step RX_PQ),
   the setting to transmit mode (step CLOSE_RX/-OPEN_TX),
   the checking of the integrity of the information (CHECK_PQ), and
   the transmission of a control signal FLC (step TX_FLC) according to the above check.
At time t21, the first identifying object ID1 compares the two dates DT1 and DT2, namely respectively that corresponding to its information PQ1 and that corresponding to the information PQ2 of the second identifying object ID2.
At time t22, if its date DT1 is subsequent to the received date DT2, a success message MSG_OK is displayed on its screen indicating that the synchronization has taken place.
By contrast, at time t22, if its date DT1 is prior, an update of its own vehicle information with that received from the second identifying object ID2 is carried out (step UPDAT_PQ illustrated in FIG. 6), and
At time t23, a success message MSG_OK is displayed on its screen indicating that the synchronization has succeeded.
At time t21, for its part, the second identifying object ID2 checks whether it has received a control signal (RX_FLC), and
At time t22, if the second determined period TIMEOUT1 is exceeded, reattempts a transmission (failure of a first transmission), or
At time t23, if the transmission has failed, it displays a failure message MSG_FAIL on its screen indicating the failure of the synchronization of the information between the two identifying objects.
By contrast, at time t22, if the second identifying object ID2 has received a control signal FLC (first variant) or when its value is correct (second variant), the second identifying object ID2 compares the two dates DT2 and DT1, namely respectively that corresponding to its information PQ2 and that corresponding to the information PQ1 of the first identifying object ID1.
At time t23, if its date DT1 is subsequent to the received date DT2, a success message MSG_OK is displayed on its screen indicating that the synchronization has taken place.
By contrast, if its date DT1 is prior, at time t23, an update of its own vehicle information with that received from the first identifying object ID1 is carried out (step UPDAT_PQ illustrated in FIG. 6), and
At time t24, a success message MSG_OK is displayed on its screen indicating that the synchronization has succeeded.

Therefore, thanks to this second embodiment, the two identifying objects ID1 and ID2 have information that is up-to-date and synchronized, that is to say that they have the same information corresponding to the last vehicle access. Two comparisons of dates DT1 and DT2 are carried out, each respectively in the first identifying object ID1 and the second identifying object ID2.

Note that, in a first variant of these two present embodiments, all of the information PQ comprised in an identifying object ID is transmitted all at once in a single packet.

In a second variant, the information PQ is transmitted in several packets. This allows a more modular transmission of information. That is to say that information of the same type can be grouped together. For example, the information concerning the state of the vehicle can be grouped together in a first packet, while the information concerning the position of the vehicle can be grouped in another packet.

For this second variant, on each transmission of a packet PQi (i=1 to N, N being an integer), there is an integrity check on this packet and an associated control signal FLC (transmitted or not transmitted depending on the first or second variant described above).

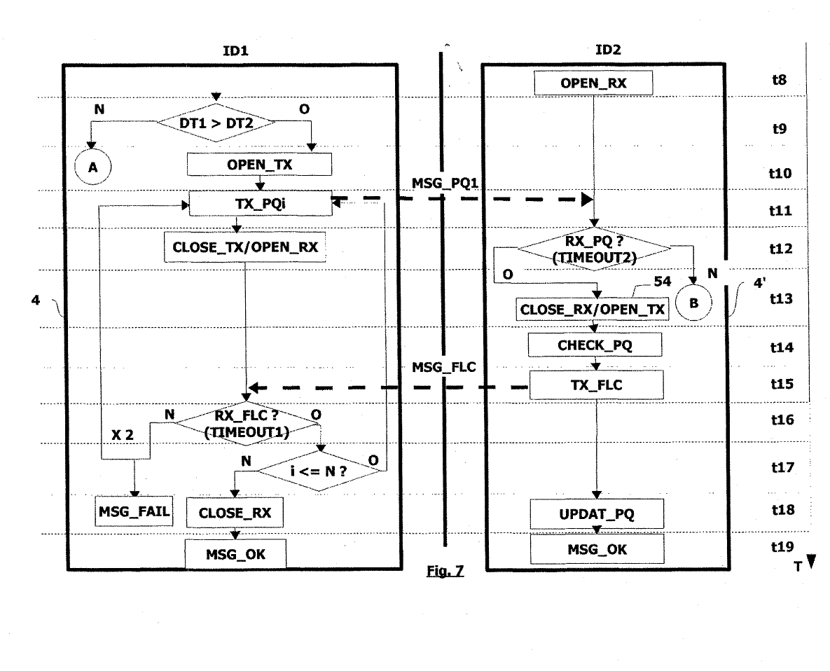

This second variant is shown in FIG. 7, in the situation of the first embodiment shown in FIG. 3, but applies in the same manner to FIG. 4 and to the second embodiment shown in FIGS. 5 and 6.

Note that, in the example taken for these two embodiments, the “vehicle access” dates DT1 and DT2 are sent when an RF communication session is opened OPEN_SSRF. This makes it possible to save execution time and to have one fewer step to execute.

Naturally, other variant embodiments may be used such as in nonlimiting examples:
the transmission of the dates DT1 and DT2 just after the opening of a communication session OPEN_SSRF (in the first embodiment, only the second date DT2 needs to be transmitted), or,
a date DT is included in the information PQ to be transmitted and is therefore transmitted at the same time as the information, or else,
each packet PQi comprises the date DT.

In a fifth step 5), after the transmission of information PQ (or a repeated failure of the transmission), the two identifying objects ID1 and ID2 close their communication session CLOSE_SSRF as illustrated in FIG. 1 and return to the idle state IDLE.

The method of the invention is applied by a device DISP for transmission of information PQ from a first identifying object ID1 for a motor vehicle V to a second identifying object ID2, shown in FIG. 7.

The device DISP comprises notably:
a control unit UC:
   for activating a synchronization mode MOD_SYNC (via a man-machine interface MMI);
   making a synchronization request comprising an opening of a two-way communication session SSRF; and
   transmitting information PQ from one identifying object to another identifying object ID2 according to a date DT associated with the information PQ to be transmitted.

For this purpose, the control unit UC makes it possible to control a transceiver ER for a physical transmission (TX_PQ) of the information PQ.

In a nonlimiting embodiment, the device DISP may also comprise this transceiver ER.

In a nonlimiting embodiment, this transceiver ER is a radiofrequency transceiver.

The control unit UC also makes it possible to carry out all the other steps and substeps described above, namely notably those of:
initiating the wake-up of an identifying object ID1, ID2;
closing a communication session CLOSE_SSRF;
updating information in one identifying object based on information received by another identifying object UPDAT_PQ;
making a comparison of dates COMP_DAT thanks to a comparator; and
checking the integrity of the received information CHECK_PQ.

The control unit UC also makes it possible to:
save vehicle information PQ with a date DT corresponding to the last vehicle access. This date can be based on the clock of the vehicle for example;
set an identifying object ID to transmit mode TX or receive mode RX, that is to say to control the transceiver ER to transmit or receive; and
enable the transceiver ER.

It is of course possible to provide a second control unit making it possible to enable the transceiver ER or else other functionalities instead of the first control unit if necessary.

The transceiver ER also makes it possible to physically receive (RX_PQ) information from another identifying object RX_PQ by means of an RF signal.

Note that such a device DISP is, in a nonlimiting embodiment, comprised in an identifying object ID. Therefore, each identifying object ID1 and ID2 comprises such a device DISP.

Moreover, as illustrated in FIG. 7, each identifying object comprises a man-machine interface MMI comprising notably:
a screen SCR on which the messages for failure MSG_FAIL or for success MSG_OK of the synchronization of the information between the identifying objects can be displayed;
a menu MENU, for example a touch-sensitive menu, making it possible to:
   wake up the identifying object ID (by means for example of a button B_UP), or else to
   select the synchronization mode (by means, for example, of a button B_MOD_SYNC).

Note that the application of the transmission method explained above can be carried out by means of a microprogram, or even a wired logic.

Therefore, the transmission device DISP may comprise a computer program product PG comprising one or more sequences of instructions that can be executed by an information processing unit such as a microprocessor, or by a processing unit of a microcontroller, of an ASIC, of a computer, etc., the execution of said sequences of instructions allowing the application of the method described.

Such a computer program PG may be written in write-only nonvolatile memory of the ROM type or in rewritable nonvolatile memory of the FLASH type for example. Said computer program PG may be written in memory at the factory or else loaded into memory or downloaded remotely into memory. The sequences of instructions may be sequences of machine instructions, or else sequences of a control language interpreted by the processing unit at the time of their execution. In the nonlimiting example of FIG. 7, the computer program PG is written into a memory of the transmission device DISP. In another example (not shown), the computer program PG may also comprise one or more sequences of instructions for applying the wake-up and synchronization mode selection functionalities of the man-machine interface MMI of the identifying object.

Naturally, the invention has been described for two identifiers, but it can be extended to more than two identifiers.

Therefore, the invention notably has the following advantages:
it makes it possible to have a synchronization that is simple to apply since it is initiated manually in particular;
it allows a user of the vehicle to use without distinction all of the identifying objects relating to his vehicle while being sure that the vehicle information in each of the identifying objects is identical and is at the same update level thanks to this possibility of synchronizing information between identifying objects;
it makes it possible to carry out a remote synchronization between identifying objects thanks to this two-way communication between the identifying objects;
it allows an identifying object to comprise vehicle information that is temporary and that is capable of changing on each use of the vehicle;
it makes it possible to obtain a synchronization of the information between identifying objects that does not consume much energy since it is initiated manually; and
it allows the actual user of the vehicle to check the vehicle information directly on the identifying object (on its screen) without being obliged to move close to a low-frequency antenna of the vehicle or go to a manufacturer or dealer. He can therefore do it at any moment, in particular far from the vehicle.

1. A method for transmitting information from a first identifying object for a motor vehicle to a second identifying object, an identifying object allowing access to said vehicle, said method comprising the steps of:
activating a synchronization mode;
opening a two-way communication session; and
transmitting information from one identifying object to the other identifying object depending on a date associated with the information to be transmitted.

2. The method for transmitting information as claimed in claim 1, wherein the two-way communication is radiofrequency communication.

3. The method for transmitting information as claimed in claim 1, wherein a transmission of information is based on a comparison of dates associated respectively with information comprised in the first identifying object and with information comprised in the second identifying object.

4. The method for transmitting information as claimed in claim 1, wherein a date corresponds to information updated after an access to the vehicle by an identifying object.

5. The method for transmitting information as claimed in claim 1, wherein a communication session is opened after a check of a vehicle number.

6. The method for transmitting information as claimed in claim 1, wherein the activation of the synchronization mode is carried out manually.

7. The method for transmitting information as claimed in any one of the preceding claims, wherein a transmission of information is carried out via a plurality of packets.

8. The method for transmitting information as claimed in any one of the preceding claims, wherein at least one date is transmitted when a two-way communication session is opened.

9. A device for transmitting information from a first identifying object for a motor vehicle to a second identifying object, an identifying object allowing access to said vehicle, said device comprising:
a control unit for:
activating a synchronization mode;
opening a two-way communication session; and
transmitting information from one identifying object to the other identifying object depending on a date associated with the information to be transmitted.

10. An identifying object for a motor vehicle capable of transmitting information to another identifying object, the identifying object allowing access to said vehicle, and comprising:
a man-machine interface in order to select a synchronization mode;
a transceiver for physically transmitting information to another identifying object; and
a device for transmitting information as claimed in the preceding claim.

11. A computer program product comprising one or more sequences of instructions that can be executed by an information-processing unit, the execution of said sequences of instructions allowing the application of the method as claimed in claim 1.
